(19) United States
(12) Patent Application Publication
(10) Pub. No.: US 2013/0284835 A1
(43) Pub. Date: Oct. 31, 2013

(54) MINCING UNIT CUTTING GROUP

(71) Applicant: Marcello Quadrana, Zola Predosa (BO) (IT)

(72) Inventor: Marcello Quadrana, Zola Predosa (BO) (IT)

(73) Assignee: EVOLUTION S.R.L., Zola Predosa (BO) (IT)

(21) Appl. No.: 13/979,277

(22) PCT Filed: Jan. 11, 2012
(86) PCT No.: PCT/IB2012/050140

§ 371 Date: Jul. 16, 2013

(30) Foreign Application Priority Data
Jan. 26, 2011 (IT) BO2011A000026

(51) Int. Cl. B02C 18/36

(52) U.S. Cl. CPC B02C 18/36
USPC 241/92

(57) ABSTRACT

The object of the invention is a cutting group for a mincing unit of a mincing machine of industrial type, with a characteristic knife holder (16), wherein said knife holder has long knives (12) and short knives (121) arranged alternately.

The present industrial invention has as object further improvements to the finding of the U.S. Pat. No. 1,337,040 (granted on Dec. 15, 2006) and subsequent U.S. Pat. No. 1,341,522 (granted on Oct. 16, 2007) in the name of the same inventor, which allow the “cutting group” of a mincing machine of industrial type to obtain improved performances, modifying and perfecting the conformation of the knives which nevertheless maintain the characteristic elasticizing slits and the mounting in floating relation with the specific knife holders, claimed in the previous patents.

With particular reference to the solutions employed in the abovementioned patents, we can confirm that the so-called “pack” is maintained, comprising the conventional, diversely-perforated discs, fixed to the stator, and the knives mounted on the rotating knife holders together with the rotor of the machine. Also the blade holder with radiated circular conformation conceptually remains, on whose spokes the knives are inserted, whereas the knives themselves are characterized by a new conformation and implant arrangement. Indeed, it was observed that the elasticity of the knife could be compromised by the fact that the slits that characterized such elasticity were obstructed during operation by the minced material waste, such that they lost effectiveness. In addition, the passage spaces for the minced material resulted insufficient for attaining the optimal delivery rate; finally, the number of knives resulted unsuitable for the desired chopping and also involved a certain rigidity of the cutting group, making it lose adherence on the perforated disc.

The present finding, which first of all has the object of eliminating the abovementioned drawbacks, is characterized by having a cutting group composed of a blade holder with annular form, stiffened by a series of spokes of conventional type or with new arrangement; on such spokes, the knives are inserted projecting from the thickness of the annular form, both on the front and on the rear, in a manner so as to carry out a double action. Such knives are characterized by a rectangular prismatic conformation with center groove so as to receive a silicone rubber insert that obtains and maintains the desired elasticity.

### BRIEF DESCRIPTION OF THE DRAWINGS

The present invention will be described in detail by making reference to the enclosed figures which should be considered merely indicative, and not limiting or binding with regard to the present patent application, in which:

FIG. 1 shows the “pack” during operation.

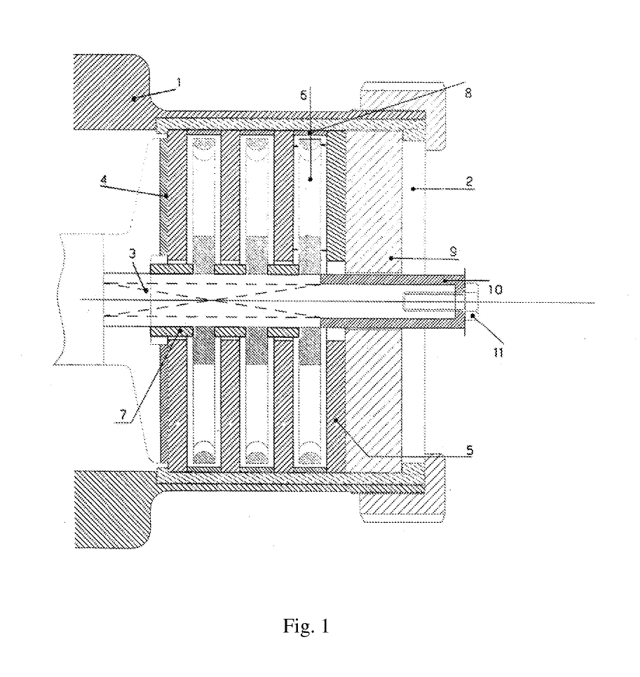

FIG. 2 shows the long knife.

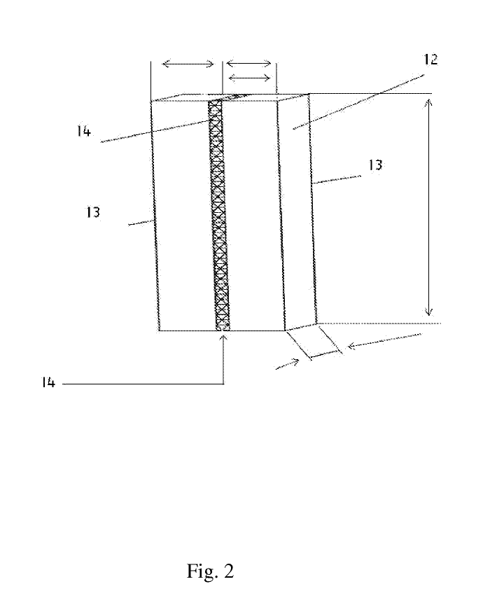

FIG. 3 shows a knife holder of conventional type with new long knives.

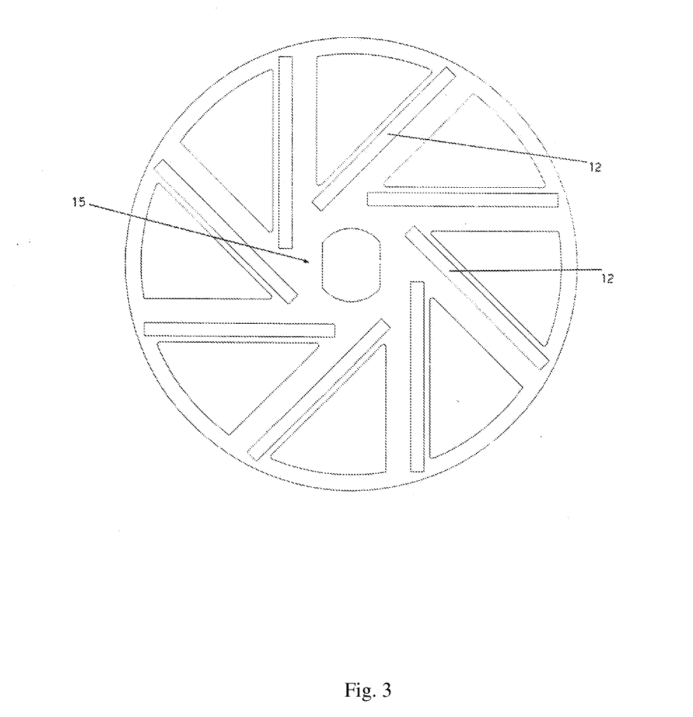

FIG. 4 shows the new knife holder with new long and short knives.

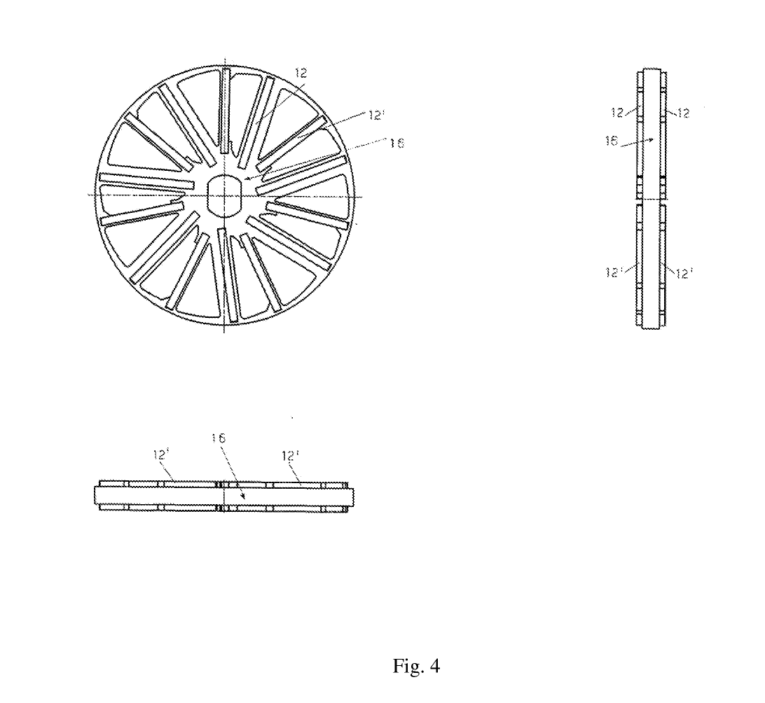

FIG. 5 shows the new knife holder with new short knives seen on the front.

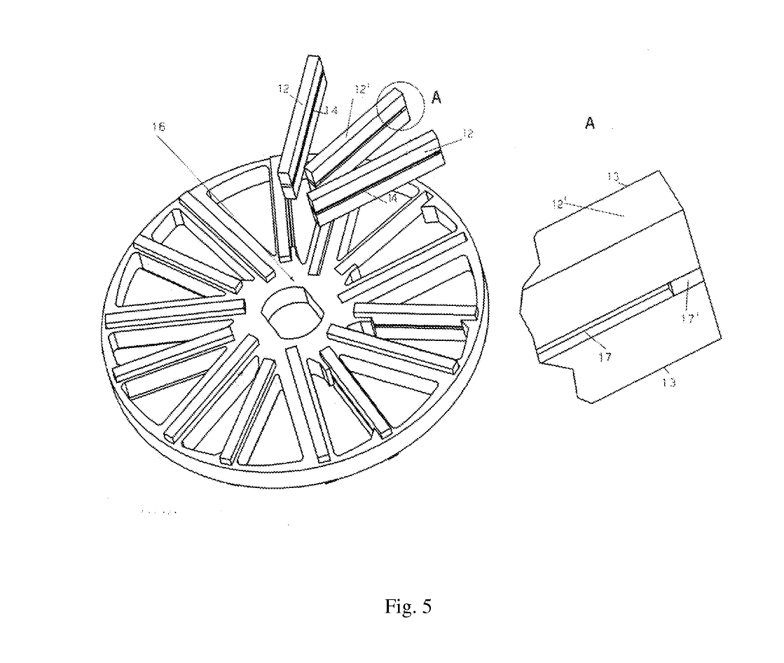

FIG. 6 shows the new knife holder with new short knives seen on the rear.

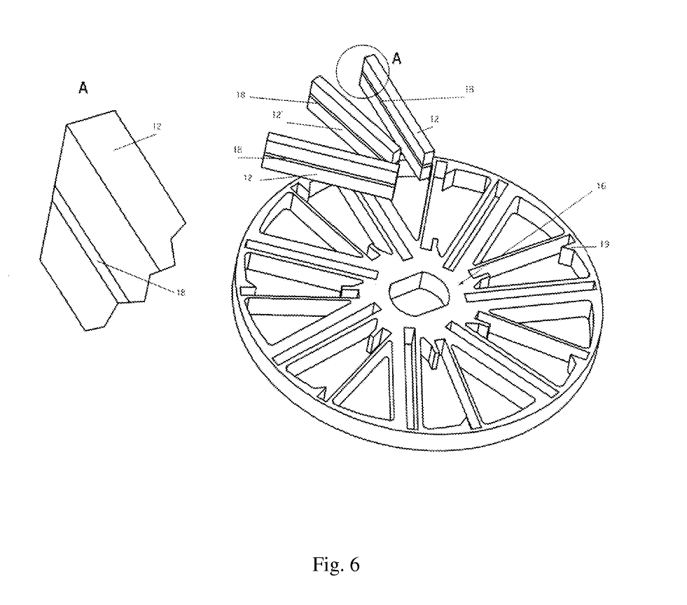

FIG. 7 shows the new knife holder evidencing the connection of the new short knives.

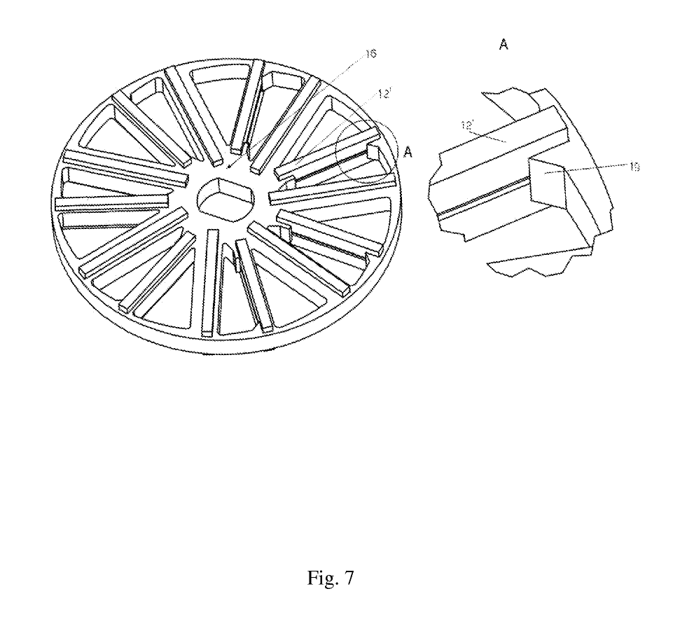

FIG. 8 shows a new version of the knife holder with double annular surface and consequent multiplication of the long knives.

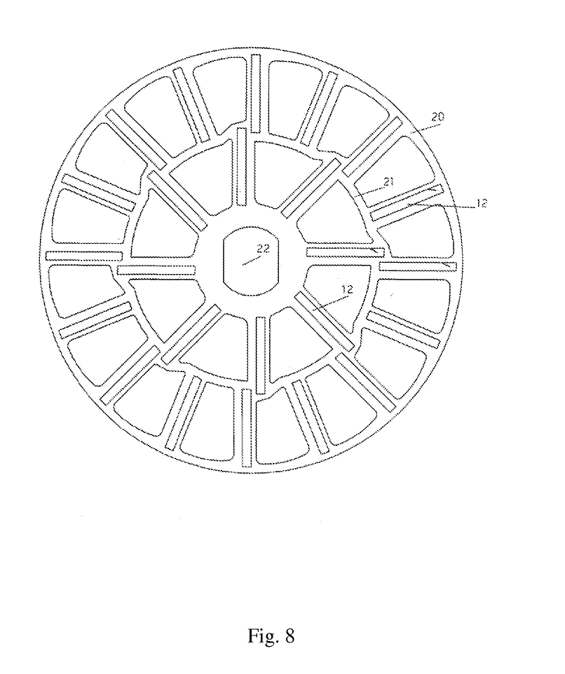

With reference to such figures, 1 indicates the stator of the machine; 2 indicates an abutment ring nut for the “pack”; 3 indicates the drive shaft; 4 indicates the first knife; 5 indicates the perforated discs with screen functions connected to the stator 1; 6 indicates the knife holders; 7 indicates the lower spacers floating on the shaft 3; 8 indicates the upper spacers placed between the discs 5; 9 indicates the final universal joint; 10 indicates a protection casing for the shaft 3 and 11 indicates a bolt for tightening and adjusting the pack in order to actuate the necessary precompression of the elasticized blades. 12 indicates the rectangular prismatic long knife with the cutting edges 13; 14 indicates the silicone rubber insert which gives elasticity to the knife; 15 indicates the conventional knife holder with the new knives 12 implanted. 16 indicates the new knife holder with the new long 12 and short 12′ knives implanted, such knives projecting from the thickness of the annular surface and with different length in order to increase the number thereof without weakening the knife holder 16. 17 indicates the front longitudinal slot which houses the silicone rubber 14; 17′ indicates a spacer inside the slot in order to prevent the undesired filling thereof with minced material waste. 18 indicates the rear slot without spacer both for the long knives 12 and the short knives 12′, due to the natural protection of the spoke on which the knives are implanted; 19 indicates the conformation of the short blade 12′ housing on the annular surface, which is different from that of the long blade 12. 20 indicates the external annular surface of the new knife holder; 21 indicates the internal annular surface with the blades of long type 12; 22 indicates the shaped hole which renders the knife holder with double annular surface integral with the drive shaft.

In practice, the details, size, materials, shape and the like of the finding embodiment can vary without departing from the domain of the present industrial patent; indeed, the finding as conceived is susceptible to numerous modifications and variations, all falling within the scope of the inventive concept. In addition, all the elements can be substituted with other technically equivalent elements.

1. Mincing unit cutting group comprising a knife holder (16) with annular surface with differently-shaped spokes, said holder connected to the drive shaft of the machine (3), and a number of projecting knives implanted on the same spokes, characterized in that said knife holder (16) has long knives (12) and short knives (12′), wherein the long knives (12) have rectangular prismatic shape with projecting sharp edges with cutting function (13), with protected central longitudinal groove (18) for the silicone rubber insert (14), and said short knives (12′) have a spacer (17′) in the unprotected front slot (17), wherein in the knife holder (16), said knives (12, 12′) are alternated and the long knives (12) are completely protected inside the spoke, whereas the short knives (12′) have the rear face exposed and constrained in (19).

2. Mincing unit cutting group according to claim 1, characterized in that the knife holder with double annular surface has a first annular surface (20) and a second annular surface (21) with knives of type (12), shorter for an improved adaptation of the knife holder on the basis of the adherence of the perforated discs (5) of the cutting group.
